(19) United States
(12) Patent Application Publication
(10) Pub. No.: US 2025/0157115 A1
(43) Pub. Date: May 15, 2025

(54) TECHNIQUES FOR PHYSICS-BASED ANIMATION FROM PARTIALLY CONDITIONED JOINTS

(71) Applicant: NVIDIA CORPORATION, Santa Clara, CA (US)

(72) Inventors: Chen TESSLER, Zichron Yaakov (IL); Gal CHECHIK, Tel Aviv (IL); Jason PENG, Vancouver (CA)

(21) Appl. No.: 18/830,218

(22) Filed: Sep. 10, 2024

Related U.S. Application Data
(60) Provisional application No. 63/548,348, filed on Nov. 13, 2023.

(51) Int. Cl. G06T 13/40

(52) U.S. Cl. CPC G06T 13/40

(57) ABSTRACT

One embodiment of a method for animating characters includes receiving a first state of a character and one or more constraints on one or more motions associated with a subset of joints belonging to the character, generating, via a trained machine learning model and based on the first state and the one or more constraints, a first action for the character to perform, and causing the character to perform the first action within a computer-based or physical environment.

### CROSS-REFERENCE TO RELATED APPLICATIONS

This application claims priority benefit of the United States Provisional Patent Application titled, “PHYSICS-BASED ANIMATION FROM PARTIALLY CONDITIONED JOINTS,” filed on Nov. 13, 2023, and having Ser. No. 63/548,348. The subject matter of this related application is hereby incorporated herein by reference.

### BACKGROUND

### Technical Field

Embodiments of the present disclosure relate generally to robotics, virtual character control, and artificial intelligence and machine learning and, more specifically, to techniques for physics-based animation from partially conditioned joints.

### Description of the Related Art

Character animation is the process of creating a series of different poses, expressions, and/or actions of a character that can be played back sequentially. Character animations can be created in various ways, including drawing animations by hand, via stop-motion, and via computer-generation.

Computer-generated character animations are typically created via a largely manual process, where animators use software to design and move three-dimensional (3D) virtual models of characters in ways the characters may move in given animation sequences. For example, an animator could use software to specify the positions and orientations of the joints associated with the head, torso, arms, etc. of a character within a number of key frames of a given animation. To create a full animation, the software can use kinematic modeling to compute the positions and orientations of the same joints within frames that reside in between the key frames. The character can then be animated to move in a manner that tracks the positions and orientations of the joints within the key frames and the in-between frames.

One drawback of the above approach for creating computer-generated character animations is that, as a general matter, the animator is required to specify the positions and orientations of all of the joints of the character within the key frames to create the animation of that character. Few, if any, conventional software programs exist that can automatically determine physically plausible positions and orientations for joints of a character that have not been specified by an animator in any key frames. Because an animator needs to specify the positions and orientations of all joints of a character in the key frames of an animation, the manual creation of character animations is typically very labor intensive and time consuming and is sometimes inaccurate.

Another drawback of the above approach for creating computer-generated character animations is the kinematic modeling used to compute the positions and orientations of joints within in-between frames does not consider the forces that cause those joints to move. Instead, the kinematic modeling computes only the motion of joints required to move between the positions and orientations of joints within key frames. Because forces are not considered, the resulting animations are oftentimes not physically realistic, which negatively impacts overall visual quality.

As the foregoing illustrates, what is needed in the art are more effective techniques for generating computer-based character animations.

### SUMMARY

One embodiment of the present disclosure sets forth a computer-implemented method for animating a character. The method includes receiving a first state of a character and one or more constraints on one or more motions associated with a subset of joints belonging to the character. The method further includes generating, via a trained machine learning model and based on the first state and the one or more constraints, a first action for the character to perform. In addition, the method includes causing the character to perform the first action within a computer-based or physical environment.

Other embodiments of the present disclosure include, without limitation, one or more computer-readable media including instructions for performing one or more aspects of the disclosed techniques as well as one or more computing systems for performing one or more aspects of the disclosed techniques.

At least one technical advantage of the disclosed techniques relative to the prior art is that, with the disclosed techniques, a physical or virtual character can be animated by specifying the positions and orientations of a subset of the joints, rather than all of the joints, of a character in any number of frames of an animation. In addition, the disclosed techniques can generate animations that are more physically realistic relative to what can be achieved by animations generated using kinematic models that do not consider the forces that cause the joints of a character to move. These technical advantages represent one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a computer-based system configured to implement one or more aspects of the various embodiments;

FIG. 2 is a more detailed illustration of the machine learning server of FIG. 1, according to various embodiments;

FIG. 3 is a more detailed illustration of the computing device of FIG. 1, according to various embodiments;

FIG. 4 is a more detailed illustration of the model trainer of FIG. 1, according to various embodiments;

FIG. 5 illustrates how the motion tracking model of FIG. 1 is trained, according to various embodiments;

FIG. 6 is a more detailed illustration of the prior module of FIG. 5, according to various embodiments;

FIG. 7 is a more detailed illustration of the control application of FIG. 1, according to various embodiments;

FIG. 8 is a more detailed illustration of how the motion tracking model of FIG. 7 is used to control a character, according to various embodiments;

FIG. 9 sets forth a flow diagram of method steps for training a motion tracking model, according to various embodiments; and

FIG. 10 is a flow diagram of method steps for generating an animation of a character given sparse motion constraints, according to various embodiments.

### DETAILED DESCRIPTION

In the following description, numerous specific details are set forth to provide a more thorough understanding of the various embodiments. However, it will be apparent to one skilled in the art that the concepts can be practiced without one or more of these specific details.

### General Overview

Embodiments of the present disclosure provide techniques for animating characters using sparse motion constraints. In some embodiments, the sparse motion constraints can specify the positions and/or orientations of any number of joints of a character in any number of frames of an animation. Given the sparse motion constraints, a control application samples a prior latent distribution generated via a trained motion tracking model given the sparse motion constraints and a current state of a character to obtain a sampled latent vector. The character can be a virtual character in a computer-based environment or a physical robot in a real-world environment, and the current state of the character can be received from the computer-based environment or sensed using sensors in the real-world environment. The control application inputs the sampled latent vector and the current state of the character into a controller of the motion tracking model to generate an action. Thereafter, the control application can control the character within the computer-based environment or the real-world environment using the action. Control of the character can result in an updated state of the character, and the foregoing process can be repeated to generate another action for controlling the character using the updated state of the character, the sparse motion constraints, and the motion tracking model.

A model trainer trains the motion tracking model, which can be a variational autoencoder (VAE) in some embodiments. In some embodiments, the model trainer first samples a motion and a timestep within the motion from a set of motion recordings. The model trainer then samples a mask that is used to mask out random joints and/or frames from the sampled motion. The model trainer computes an action for each frame using the motion tracking model, the masked motion, and a current state of the character. The model trainer simulates the character performing the action within the environment and receives a motion of the character from the environment. Then, the model trainer computes a reward based on a comparison of the received motion with the sampled motion, and the model trainer updates parameters of the motion tracking model based on the reward.

The techniques for animating characters have many real-world applications. For example, those techniques could be used to animate a character in a virtual or extended reality (XR) environment, such as a gaming environment. As another example, those techniques could be used to control a physical robot in a real-world environment.

The above examples are not in any way intended to be limiting. As persons skilled in the art will appreciate, as a general matter, the techniques for animating characters described herein can be implemented in any suitable application.

### System Overview

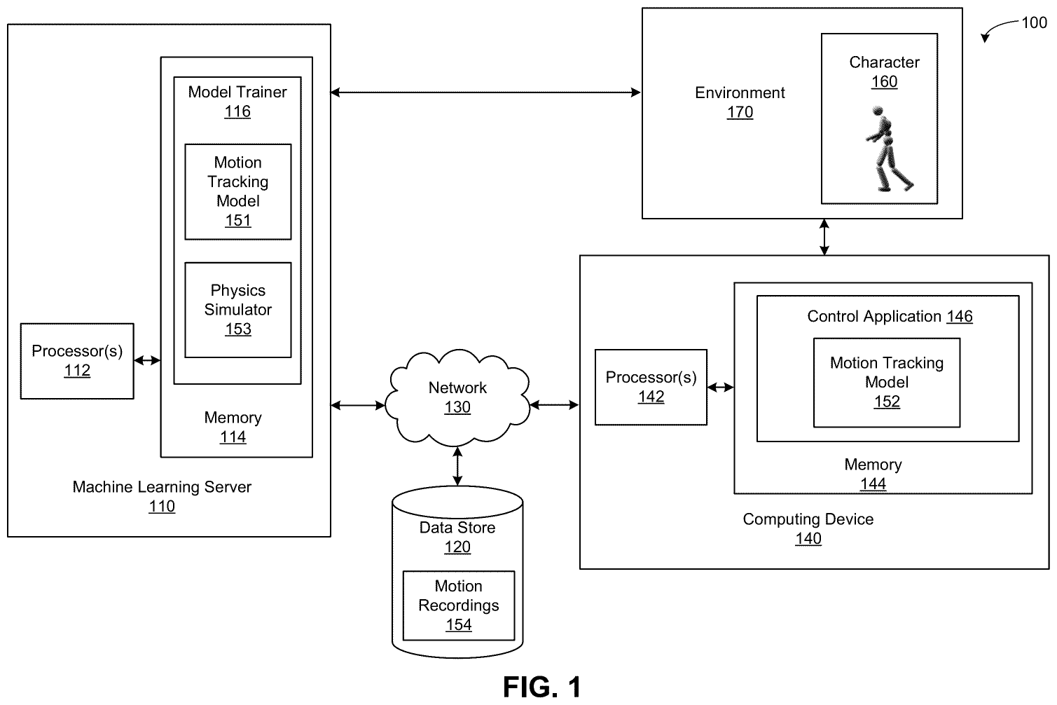

FIG. 1 illustrates a block diagram of a computer-based system 100 configured to implement one or more aspects of various embodiments. As shown, the system 100 includes a machine learning server 110, a data store 120, and a computing system 140 in communication over a network 130, which can be a wide area network (WAN) such as the Internet, a local area network (LAN), a cellular network, and/or any other suitable network.

As shown, a model trainer 116 executes on one or more processors 112 of the machine learning server 110 and is stored in a system memory 114 of the machine learning server 110. The processor(s) 112 receive user input from input devices, such as a keyboard or a mouse. In operation, the processor(s) 112 may include one or more primary processors of the machine learning server 110, controlling and coordinating operations of other system components. In particular, the processor(s) 112 can issue commands that control the operation of one or more graphics processing units (GPUs) (not shown) and/or other parallel processing circuitry (e.g., parallel processing units, deep learning accelerators, etc.) that incorporates circuitry optimized for graphics and video processing, including, for example, video output circuitry. The GPU(s) can deliver pixels to a display device that can be any conventional cathode ray tube, liquid crystal display, light-emitting diode display, and/or the like.

The system memory 114 of the machine learning server 110 stores content, such as software applications and data, for use by the processor(s) 112 and the GPU(s) and/or other processing units. The system memory 114 can be any type of memory capable of storing data and software applications, such as a random-access memory (RAM), a read-only memory (ROM), an erasable programmable read-only memory (EPROM or Flash ROM), or any suitable combination of the foregoing. In some embodiments, a storage (not shown) can supplement or replace the system memory 114. The storage can include any number and type of external memories that are accessible to the processor 112 and/or the GPU. For example, and without limitation, the storage can include a Secure Digital Card, an external Flash memory, a portable compact disc read-only memory (CD-ROM), an optical storage device, a magnetic storage device, and/or any suitable combination of the foregoing.

The machine learning server 110 shown herein is for illustrative purposes only, and variations and modifications are possible without departing from the scope of the present disclosure. For example, the number of processors 112, the number of GPUs and/or other processing unit types, the number of system memories 114, and/or the number of applications included in the system memory 114 can be modified as desired. Further, the connection topology between the various units in FIG. 1 can be modified as desired. In some embodiments, any combination of the processor(s) 112, the system memory 114, and/or GPU(s) can be included in and/or replaced with any type of virtual computing system, distributed computing system, and/or cloud computing environment, such as a public, private, or a hybrid cloud system.

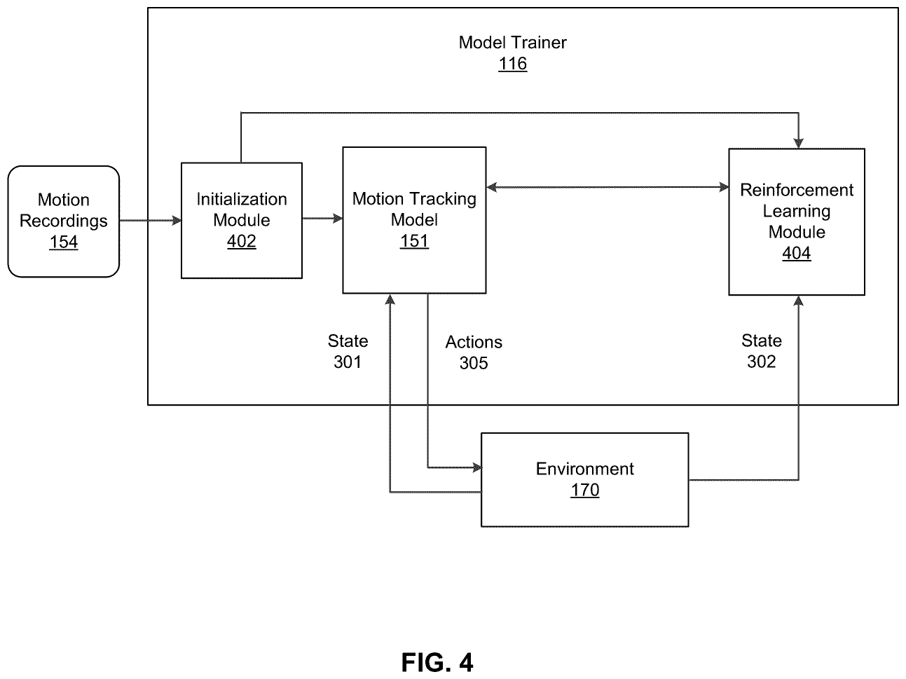

In some embodiments, the model trainer 116 is configured to train one or more machine learning models, including a motion tracking model 150 that is trained to generate actions for animating a character given a sparse set of joint constraints. Techniques that the model trainer 116 can employ to train the motion tracking model 150 are discussed in greater detail below in conjunction with FIGS. 4-5 and 9. Training data and/or trained (or deployed) machine learning models, including the motion tracking model 150, can be stored in the data store 120. In some embodiments, the data store 120 can include any storage device or devices, such as fixed disc drive(s), flash drive(s), optical storage, network attached storage (NAS), and/or a storage area-network (SAN). Although shown as accessible over the network 130, in at least one embodiment the machine learning server 110 can include the data store 120.

Illustratively, data store 120 also stores motion recordings 154. The motion recordings 154 are used for training motion tracking model 152. In some embodiments, the motion recordings 154 include recorded motions of humans that are used to evaluate the generated motions of motion tracking model 152. In various examples, the motion recordings 154 are curated from various human activities that are, for example, collected through motion capture technologies.

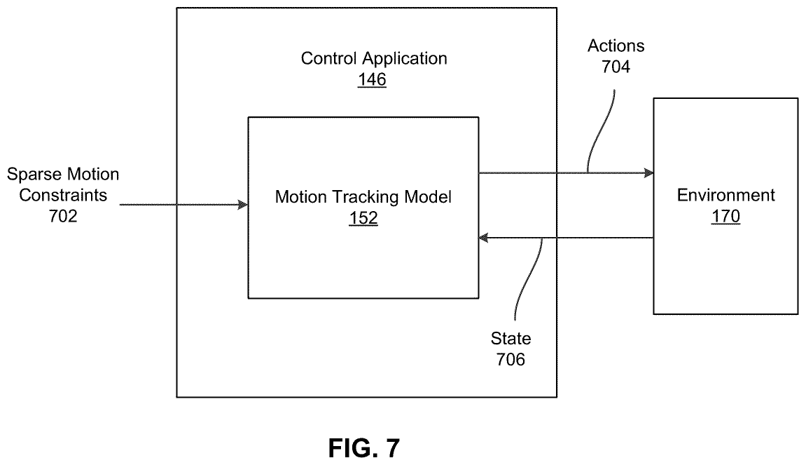

As shown, a control application 146 that uses the trained motion tracking model 152 is stored in memory 144, and executes on processor(s) 142, of the computer device 140. The control application 146 is discussed in greater detail below in conjunction with FIGS. 7-8 and 10. Illustratively, control application 146 uses the motion tracking model 152 to control a character 160 to move within an environment 170.

The environment 170, in which the character 160 performs actions, can be either a computer-based environment or a physical environment. A computer-based environment can be simulated in any technically feasible manner in some embodiments, such as using a 3D engine, a generative model (e.g., a neural network) that predicts the next state given an action, etc. For example, in a computer-based 3D virtual environment, the character 160 could navigate a digital landscape, such as a simulation of a cityscape with moving traffic and pedestrians, a fantasy world with dynamic terrain and interactive elements, and/or the like. Computer-based environments can be used in video game development, virtual reality (VR) applications, advanced AI training simulations, and/or the like. In a physical environment, the character 160, such as a humanoid robot, can navigate real-world scenarios, such as a robot moving through a warehouse to perform logistics operations, maneuvering in a hospital to deliver supplies, operating in hazardous environments such as nuclear facilities where human presence is risky, and/or the like.

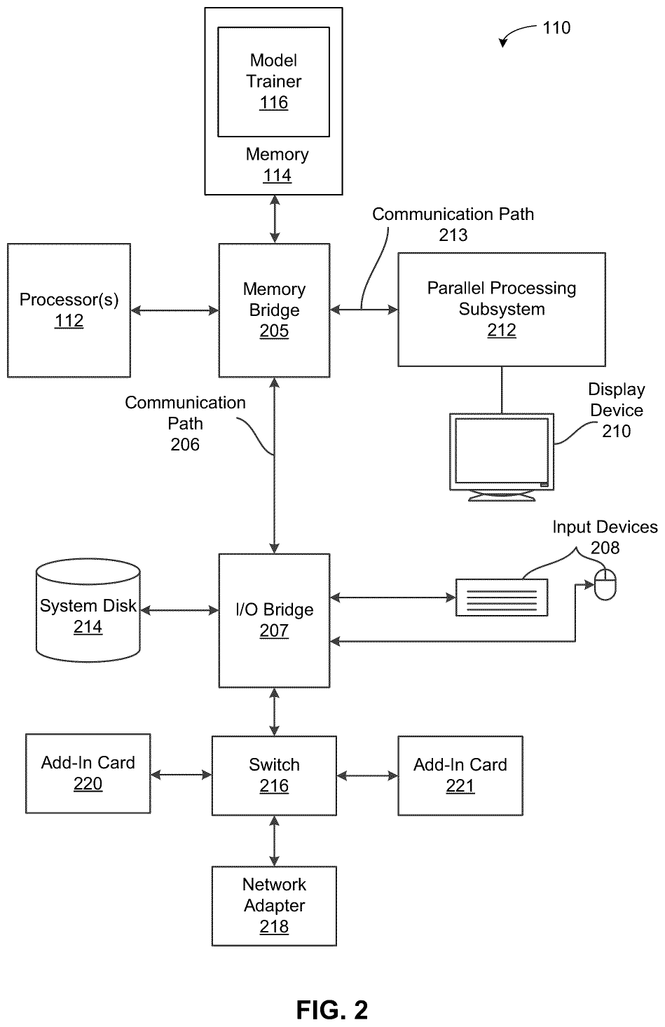

FIG. 2 is a more detailed illustration of the machine learning server 110 of FIG. 1, according to various embodiments. In some embodiments, the machine learning server 110 can include any type of computing system, including, without limitation, a server machine, a server platform, a desktop machine, a laptop machine, a hand-held/mobile device, a digital kiosk, an in-vehicle infotainment system, and/or a wearable device. In some embodiments, the machine learning server 110 is a server machine operating in a data center or a cloud computing environment that provides scalable computing resources as a service over a network.

In some embodiments, the machine learning server 110 includes, without limitation, the processor(s) 112 and the memory (ies) 114 coupled to a parallel processing subsystem 212 via a memory bridge 205 and a communication path 206. Memory bridge 205 is further coupled to an I/O (input/output) bridge 207 via a communication path 206, and I/O bridge 207 is, in turn, coupled to a switch 216.

In some embodiments, the I/O bridge 207 is configured to receive user input information from optional input devices 208, such as a keyboard, mouse, touch screen, sensor data analysis (e.g., evaluating gestures, speech, or other information about one or more uses in a field of view or sensory field of one or more sensors), and/or the like, and forward the input information to the processor(s) 112 for processing. In some embodiments, the machine learning server 110 can be a server machine in a cloud computing environment. In such embodiments, the machine learning server 110 can not include input devices 208, but can receive equivalent input information by receiving commands (e.g., responsive to one or more inputs from a remote computing device) in the form of messages transmitted over a network and received via a network adapter 218. In some embodiments, the switch 216 is configured to provide connections between I/O bridge 207 and other components of the machine learning server 110, such as a network adapter 218 and various add in cards 220 and 221.

In some embodiments, the I/O bridge 207 is coupled to a system disk 214 that may be configured to store content and applications and data for use by the processor(s) 112 and the parallel processing subsystem 212. In some embodiments, the system disk 214 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid state storage devices. In some embodiments, other components, such as universal serial bus or other port connections, compact disc drives, digital versatile disc drives, film recording devices, and the like, may be connected to the I/O bridge 207 as well.

In some embodiments, the memory bridge 205 may be a Northbridge chip, and the I/O bridge 207 may be a Southbridge chip. In addition, the communication paths 206 and 213, as well as other communication paths within the machine learning server 110, can be implemented using any technically suitable protocols, including, without limitation, AGP (Accelerated Graphics Port), HyperTransport, or any other bus or point to point communication protocol known in the art.

In some embodiments, the parallel processing subsystem 212 comprises a graphics subsystem that delivers pixels to an optional display device 210 that may be any conventional cathode ray tube, liquid crystal display, light-emitting diode display, and/or the like. In such embodiments, the parallel processing subsystem 212 may incorporate circuitry optimized for graphics and video processing, including, for example, video output circuitry. Such circuitry may be incorporated across one or more parallel processing units (PPUs), also referred to herein as parallel processors, included within the parallel processing subsystem 212.

In some embodiments, the parallel processing subsystem 212 incorporates circuitry optimized (e.g., that undergoes optimization) for general purpose and/or compute processing. Again, such circuitry may be incorporated across one or more PPUs included within the parallel processing subsystem 212 that are configured to perform such general purpose and/or compute operations. In yet other embodiments, the one or more PPUs included within the parallel processing subsystem 212 may be configured to perform graphics processing, general purpose processing, and/or compute processing operations. The system memory 114 includes at least one device driver configured to manage the processing operations of the one or more PPUs within the parallel processing subsystem 212. In addition, the system memory 114 includes the model trainer 116, discussed in greater detail below in conjunction with FIGS. 4-5 and 9. Although described herein primarily with respect to the model trainer 116, techniques disclosed herein can also be implemented, either entirely or in part, in other software and/or hardware, such as in the parallel processing subsystem 212.

In some embodiments, the parallel processing subsystem 212 can be integrated with one or more of the other elements of FIG. 2 to form a single system. For example, the parallel processing subsystem 212 can be integrated with the processor(s) 112 and other connection circuitry on a single chip to form a system on a chip (SoC).

In some embodiments, the processor(s) 112 includes the primary processor of the machine learning server 110, controlling and coordinating operations of other system components. In some embodiments, the processor(s) 112 issues commands that control the operation of PPUs. In some embodiments, the communication path 213 is a PCI Express link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of processor(s) 112, and the number of parallel processing subsystems 212, can be modified as desired. For example, in some embodiments, the system memory 114 could be connected to the processor(s) 112 directly rather than through the memory bridge 205, and other devices can communicate with the system memory 114 via the memory bridge 205 and the processor(s) 112. In other embodiments, the parallel processing subsystem 212 can be connected to the I/O bridge 207 or directly to the processor(s) 112, rather than to the memory bridge 205. In still other embodiments, the I/O bridge 207 and the memory bridge 205 can be integrated into a single chip instead of existing as one or more discrete devices. In certain embodiments, one or more components shown in FIG. 2 may not be present. For example, the switch 216 could be eliminated, and the network adapter 218 and add in cards 220, 221 would connect directly to the I/O bridge 207.

Lastly, in certain embodiments, one or more components shown in FIG. 2 may be implemented as virtualized resources in a virtual computing environment, such as a cloud computing environment. In particular, the parallel processing subsystem 212 may be implemented as a virtualized parallel processing subsystem in some embodiments. For example, the parallel processing subsystem 212 may be implemented as a virtual graphics processing unit(s) (vGPU(s)) that renders graphics on a virtual machine(s) (VM(s)) executing on a server machine(s) whose GPU(s) and other physical resources are shared across one or more VMs.

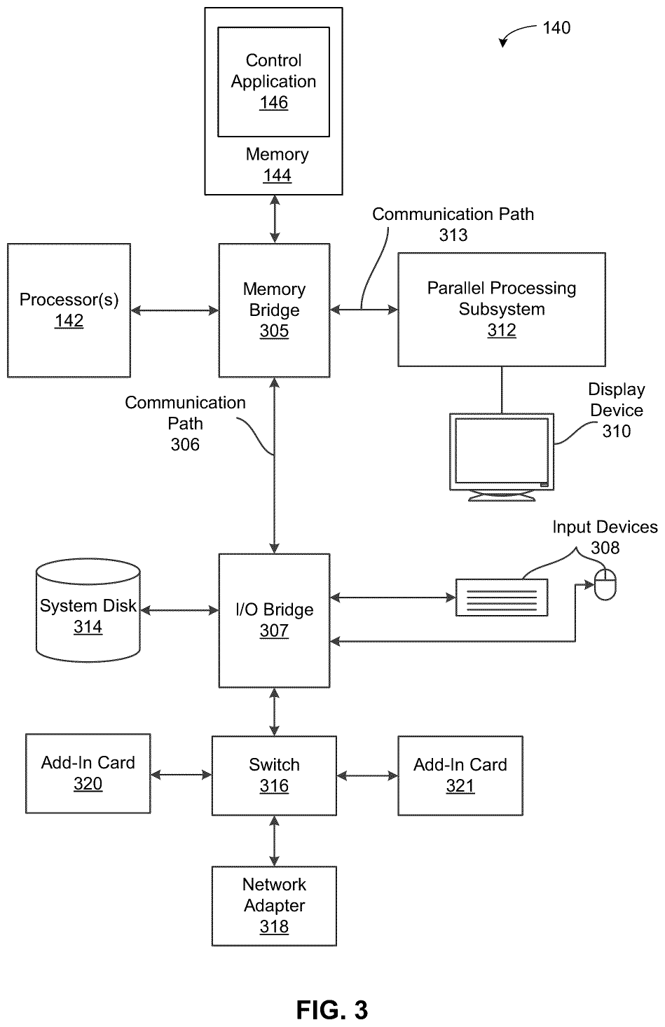

FIG. 3 is a more detailed illustration of the computing system 140 of FIG. 1, according to various embodiments. In some embodiments, the computing system 140 can include any type of computing system, including, without limitation, a server machine, a server platform, a desktop machine, a laptop machine, a hand-held/mobile device, a digital kiosk, an in-vehicle infotainment system, and/or a wearable device. In some embodiments, the computing system 140 is a server machine operating in a data center or a cloud computing environment that provides scalable computing resources as a service over a network.

In some embodiments, the computing system 140 includes, without limitation, the processor(s) 142 and the memory (ies) 144 coupled to a parallel processing subsystem 312 via a memory bridge 305 and a communication path 306. Memory bridge 305 is further coupled to an I/O (input/output) bridge 307 via a communication path 306, and I/O bridge 307 is, in turn, coupled to a switch 316.

In some embodiments, the I/O bridge 307 is configured to receive user input information from optional input devices 308, such as a keyboard, mouse, touch screen, sensor data analysis (e.g., evaluating gestures, speech, or other information about one or more uses in a field of view or sensory field of one or more sensors), and/or the like, and forward the input information to the processor(s) 142 for processing. In some embodiments, the computing system 140 can be a server machine in a cloud computing environment. In such embodiments, the computing system 140 can not include the input devices 308, but can receive equivalent input information by receiving commands (e.g., responsive to one or more inputs from a remote computing device) in the form of messages transmitted over a network and received via a network adapter 318. In some embodiments, the switch 316 is configured to provide connections between I/O bridge 307 and other components of the computing system 140, such as a network adapter 318 and various add in cards 320 and 321.

In some embodiments, the I/O bridge 307 is coupled to a system disk 314 that may be configured to store content and applications and data for use by the processor(s) 312 and the parallel processing subsystem 312. In some embodiments, the system disk 314 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid state storage devices. In some embodiments, other components, such as universal serial bus or other port connections, compact disc drives, digital versatile disc drives, film recording devices, and the like, may be connected to the I/O bridge 307 as well.

In some embodiments, the memory bridge 305 may be a Northbridge chip, and the I/O bridge 307 may be a Southbridge chip. In addition, the communication paths 306 and 313, as well as other communication paths within the computing system 140, can be implemented using any technically suitable protocols, including, without limitation, AGP (Accelerated Graphics Port), HyperTransport, or any other bus or point to point communication protocol known in the art.

In some embodiments, the parallel processing subsystem 312 comprises a graphics subsystem that delivers pixels to an optional display device 310 that may be any conventional cathode ray tube, liquid crystal display, light-emitting diode display, and/or the like. In such embodiments, the parallel processing subsystem 312 may incorporate circuitry optimized for graphics and video processing, including, for example, video output circuitry. Such circuitry may be incorporated across one or more parallel processing units (PPUs), also referred to herein as parallel processors, included within the parallel processing subsystem 312.

In some embodiments, the parallel processing subsystem 312 incorporates circuitry optimized (e.g., that undergoes optimization) for general purpose and/or compute processing. Again, such circuitry may be incorporated across one or more PPUs included within the parallel processing subsystem 312 that are configured to perform such general purpose and/or compute operations. In yet other embodiments, the one or more PPUs included within the parallel processing subsystem 312 may be configured to perform graphics processing, general purpose processing, and/or compute processing operations. The system memory 144 includes at least one device driver configured to manage the processing operations of the one or more PPUs within the parallel processing subsystem 312. In addition, the system memory 144 includes the control application 146, discussed in greater detail in conjunction with FIGS. 7-8 and 10. Although described herein primarily with respect to the control application 146, techniques disclosed herein can also be implemented, either entirely or in part, in other software and/or hardware, such as in the parallel processing subsystem 312.

In some embodiments, the parallel processing subsystem 312 can be integrated with one or more of the other elements of FIG. 3 to form a single system. For example, the parallel processing subsystem 312 can be integrated with the processor(s) 142 and other connection circuitry on a single chip to form a system on a chip (SoC).

In some embodiments, the processor(s) 142 includes the primary processor of the computing system 140, controlling and coordinating operations of other system components. In some embodiments, the processor(s) 142 issues commands that control the operation of PPUs. In some embodiments, the communication path 313 is a PCI Express link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of processor(s) 312, and the number of parallel processing subsystems 312, can be modified as desired. For example, in some embodiments, the system memory 144 could be connected to the processor(s) 142 directly rather than through the memory bridge 305, and other devices can communicate with system memory 144 via the memory bridge 305 and the processor(s) 142. In other embodiments, the parallel processing subsystem 312 can be connected to the I/O bridge 307 or directly to the processor(s) 142, rather than to the memory bridge 305. In still other embodiments, I/O bridge 307 and the memory bridge 305 can be integrated into a single chip instead of existing as one or more discrete devices. In certain embodiments, one or more components shown in FIG. 3 may not be present. For example, the switch 316 could be eliminated, and the network adapter 318 and add the in cards 320, 321 would connect directly to the I/O bridge 307. Lastly, in certain embodiments, one or more components shown in FIG. 3 may be implemented as virtualized resources in a virtual computing environment, such as a cloud computing environment. In particular, the parallel processing subsystem 312 may be implemented as a virtualized parallel processing subsystem in some embodiments. For example, the parallel processing subsystem 312 may be implemented as a virtual graphics processing unit(s) (vGPU(s)) that renders graphics on a virtual machine(s) (VM(s)) executing on a server machine(s) whose GPU(s) and other physical resources are shared across one or more VMs.

### Physics-Based Animation From Partially Conditioned Joints

FIG. 4 is a more detailed illustration of the model trainer 116 of FIG. 1, according to various embodiments. As shown, the model trainer 116 includes an initialization module 402, the motion tracking model 151, and a reinforcement learning module 404.

During training, a character 160 (included in the environment 170) interacts with the environment 170 according to actions 305 generated using the motion tracking model 151 that is being trained. The motion tracking model 151 is a partially constrained physical controller that receives as input a current state 301 of the character 160 and a sparse set of body parts and future timesteps. Given such inputs, the motion tracking model 151 generates the actions 305, which in some embodiments can be motor actuations such that the character 160 tracks the requested body parts at the requested timeframes. For example, the actions 305 could be one-step primitive motor controls.

The initialization module 402 generates the sparse set of body parts and future timesteps by sampling from motion recordings 154 and sampling a random mask for future poses. The motion recordings 154 can be a motion capture dataset that includes captured motions of humans performing various motions. In some embodiments, the motion recordings 154 can include the positions and rotations for each joint in each frame of the captured motions. The initialization module 402 samples a motion from the motion recordings 154 and a timestep within the motion from which to begin. The initialization module 402 further samples a random mask that masks out randomly selected joints from randomly selected frames of the sampled motion to generate sparse future poses in which the selected joints and/or frames are missing, which can include no masking in some cases where no joints or frames are randomly selected to be masked out.

After the character 160 is simulated performing an action generated by the motion tracking model 151 given the state 301 and the sparse set of body parts and future timesteps output by the initialization module 402, the reinforcement learning module 404 learns to recover the original recorded motion based on a comparison of a next state 302 of the character 170 from the simulation (which can also be input into the motion tracking model 151 at a subsequent time step) to a ground truth state of the character 170 in a corresponding frame of the motion sampled by the initialization module 402. In particular, the reinforcement learning module 404 computes a reward for tracking the sparse set of body parts for the current frame based on the comparison. The reinforcement learning module 404 then updates parameters of the motion tracking model 151 using the reward and a backpropagation technique. In some embodiments, a proximal policy optimization (PPO) technique can be employed during the training.

More formally, to train the motion tracking model 151, which is a sparse-constrained motion controller, a reinforcement learning agent can interact with an environment (e.g., the environment 170) according to a policy π. At each step t, the agent observes a state sₜ and samples an action at from the policy αₜ˜π(αₜ|sₜ). The environment then transitions to the next state sₜ₊₁ according to the environment dynamics p(sₜ₊₁|sₜ,αₜ). The goal of the agent is to learn a policy that maximizes the discounted cumulative reward:

$$J = {𝔼}_{p ( τ \vert π )} [ {Σ}_{t = 0}^{T} {γ}^{t} {r}_{t} \vert {s}_{0} = s ] , \qquad ( 1 )$$

where p(τ|π)=p(s₀)Πₜ₌₀^{T-1}p(sₜ₊₁|sₜ,αₜ)π(αₜ|sₜ) is the likelihood of a trajectory τ=(s₀, α₀, r₀, . . . , s_{T-1}, α_{T-1}, r_{T-1}, s_{T}), and γ∈[0,1) is a discount factor that determines the effective horizon of the policy.

In the task of physics-based motion tracking, the goal is to generate controls (such as motor actuations) that enable a simulated character to generate a sequence of simulated poses qₜ=(pₜ,θₜ) that closely resemble a target kinematic motion \hat{q}=(\hat{p},\hat{θ}). A motion can be represented as a sequence of poses through time q_{t:t+K}, where each kinematic pose qₜ=(pₜ,θₜ) is represented by the 3D cartesian positions of a character's J joints pₜ=(pₜ⁰,pₜ¹, . . . , pₜ^{J}) and their local rotations θₜ=(θₜ⁰,θₜ¹, . . . , θₜ^{J}).

The goal of training the motion tracking model 151 is to extend beyond the common case of tracking full-body reference motions to tracking sparse reference motions, which are denoted herein by \hat{q}ₜ^{sparse}. A sparse pose provides an incomplete representation of the joint positions and rotations, where only the features of some joints may be observed. The set of observed joints can also vary from frame to frame within a reference motion. For example, some frames may include a full description of the pose, while joints in other frames may be fully unobserved. The initialization module 402 can obtain a sparse motion by taking a full-body motion and masking out various elements in space and time, after which the motion tracking model 151 can be trained using reinforcement learning based on the sparse motion.

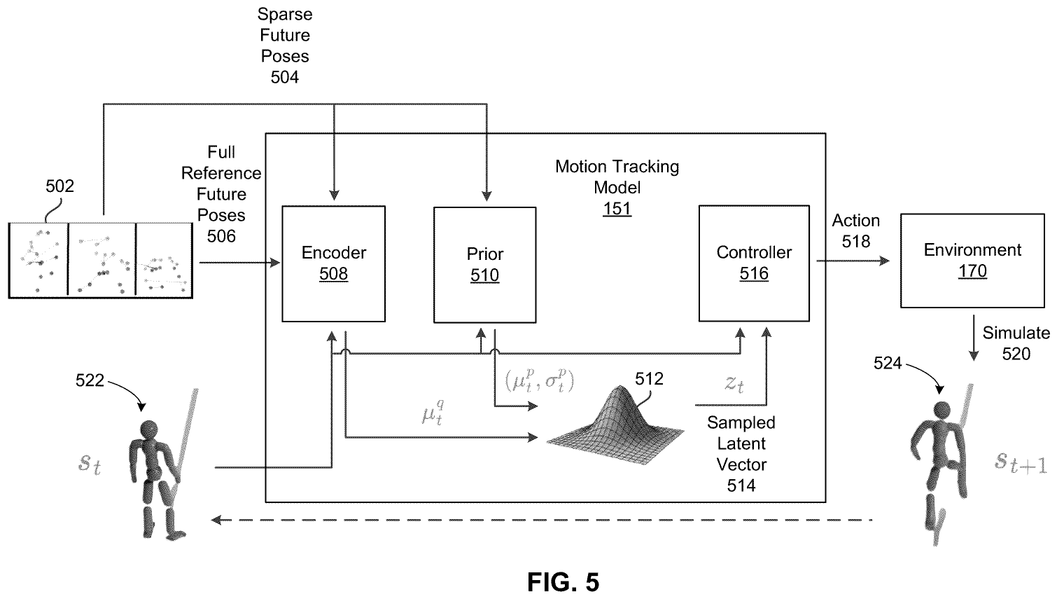

FIG. 5 illustrates how the motion tracking model 151 of FIG. 1 is trained, according to various embodiments. As shown, in some embodiments, the motion tracking model 151 can be a variational autoencoder (VAE) that includes an encoder 508, a prior module 510, and a controller 516 that is a decoder. Although described herein primarily with respect to an VAE, any technically feasible machine learning model, including other generative models such as diffusion models, can be used as the motion tracking model 151 in some embodiments. For example, in some embodiments in which a VAE is not used, the motion tracking model 151 can directly map a current state of a character and masked objectives to an action. In such cases, the motion tracking model 151 can have any suitable architecture, such as a single model that is trained and then re-used at inference time, rather than multiple models such as an encoder, a prior module, and a controller as in the case of the VAE. To train the motion tracking model 151, the model trainer 116 first samples a motion from the motion recordings 154 and a timestep within the motion, shown as sampled motion 502. In some embodiments, the sampling can prioritize training on most difficult to imitate motions using a per-segment motion sampling rate that is proportional to the number of times the motion tracking model 151 failed to track a frame belonging to that segment, relative to the total number of frames spent within that segment and smoothed over time using standard discounted accumulation.

The model trainer 116 also samples a mask for the sampled motion 502. In some embodiments, the mask can mask out randomly selected joints from randomly selected frames of the sampled motion 502 (which, as described above in conjunction with FIG. 4, can include no masking in some cases) to generate sparse future poses 504 in which the selected joints and/or frames are missing. The model trainer 116 inputs the sparse future poses 504 and a current state 522 of the character into a prior module 510, which is trained to learn which part of a latent space to use given the inputs, shown as a prior latent distribution 512. The prior latent distribution 512 is a distribution in latent space that represents the solutions, so the prior distribution can be seen as a distribution over possible solutions. The model trainer 116 also inputs the sparse future poses 504, full reference future poses 506 from the sampled motion 502, and the current state 522 into the encoder 508, which observes the full reference motion that needs to be generated and is also used to learn the prior latent distribution 512 that needs to be used.

To control the character within the environment 170, the model trainer 116 samples the latent distribution 512 using outputs of the prior module 510 and the encoder 508 to obtain a sampled latent vector 514. Then, the model trainer 116 inputs the sampled latent vector 514 and the current state 522 of the character into the controller 516, which outputs an action 518. Thereafter, the model trainer 116 simulates the character performing the action and receives a character motion from the environment 170. In some embodiments, the model trainer 116 transmits the action 518 to a controller of the character, such as a proportional derivative (PD) controller, that controls joints of the character to move within the environment 170 according to the action 518.

The simulation 520 of the character performing the action 518 results in an updated state 524 of the character, which the model trainer 116 uses to compute a reward for updating parameters of the motion tracking model 151. In some embodiments, the model trainer 116 computes a reward based on a comparison of the updated state 524 after simulation 520 with the state in a corresponding frame of the sampled motion 502. In some embodiments, the reward can include (1) a term that rewards lesser distances between received positions of joints and positions of the joints in the sampled motion, (2) a term that rewards lesser angles between received rotations of joints and rotations of joints in the sampled motion, (3) a term that rewards lesser differences between a received height of a root joint and a height of the root joint in the sampled motion, (4) a term that rewards lesser differences between received velocities of the joints and velocities of the joints in the sampled motion, and (5) a term that penalizes energy consumption in the received motion. More generally, in some embodiments, the reward can be any metric of comparison (i.e., similarity metric) between the generated motion and the target kinematic motion from the corresponding frame of the sampled motion 502. The model trainer 116 can update the parameters of the encoder 508, the prior module 510, and the controller 516 in the motion tracking model 151 using the reward and a backpropagation technique. In some embodiments, a PPO technique can be used during the training.

In some embodiments, the model trainer 116 can also determine whether to terminate training using the sampled motion 502 early. In such cases, the model trainer 116 can determine to terminate early if the received character motion in the updated state 524 has deviated too much in position and/or orientation from the sampled motion 502 that is used as a reference. More generally, in some embodiments, the model trainer 116 can determine to terminate early based on a failure that is defined as a mismatch in any technically feasible similarity metric.

More formally, in some embodiments, the prior module 510 takes as input a series of K future sparse constraints and outputs the distribution 512 over the latent space p(z|sₜ, q_{t+1:t+K}^{sparse}), from which the motion tracking model 151 can later sample. The encoder 508, used only during training, also observes unmasked full-body poses. The role of the encoder 508 is to overcome ambiguity between the acceptable solutions by providing a residual to the prior distribution 512. The controller 516, also referred to as a decoder, observes the current state sₜ and the sampled latent zₜ and produces an action distribution π(α|sₜ,zₜ).

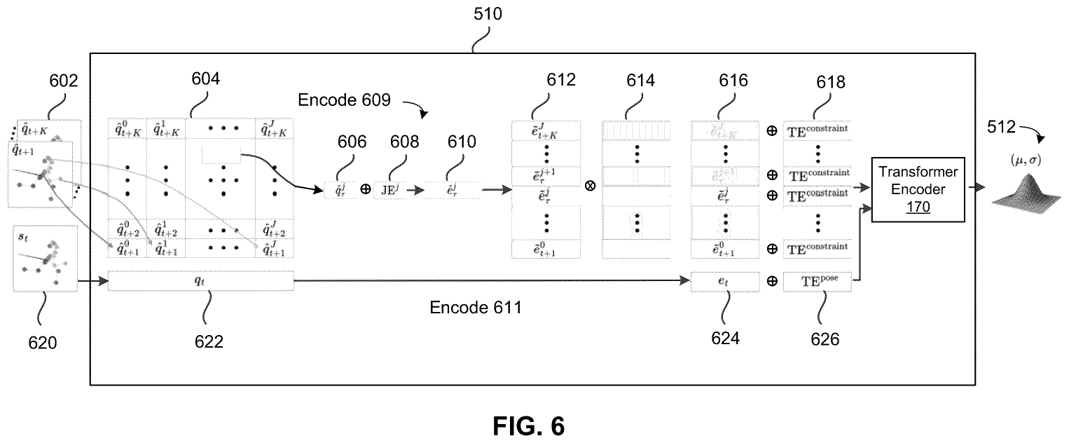

In some embodiments, the motion tracking model 151 can be trained using reinforcement learning with a motion-tracking objective, the goal of which is to generate actions that reproduce a desired reference motion given sparse observations for future frames. The sparsity may occur both in time and space (joints). Compared to full-body motion imitation, as the problem becomes underconstrained, sparsity introduces a key problem of ambiguity. For example, when the reference motion only specifies the position of the pelvis, there are multiple possible full-body motions (solutions) that satisfy the specified constraints (e.g. the hands might remain static next to the body, or they swing by the character's side). To address the aforementioned challenges, the motion tracking model 151 can be implemented as a VAE with a learned prior, a framework capable of modeling these types of multi-modal solutions. As described, the motion tracking model 151 includes three learned models: the prior module 510 sparse p(zₜ^{p}|sₜ,q_{t+1:t+k}^{sparse}), the encoder 508 q(zₜ^{q}|sₜ,q_{t+1:t+K},q_{t+1:t+K}^{sparse}), which shifts the latent distribution during training, and a controller 516 (decoder policy) π(αₜ|sₜ,zₜ). The learnable prior module 510 enables the system to distinguish between multiple valid solutions for differing constraints, such that the action distribution for a head-only constraint can capture a larger diversity of motions as opposed to a VR (head and hands) constraint. In some embodiments, the encoder 508, as well as a critic (not shown) that sees the full pose and provides a prediction of the cumulative discounted reward that the controller 516 is expected to receive based on the motion the controller 516 is conditioned on, are both modeled as fully-connected networks. In such cases, each of the encoder 508 and the critic observe the current pose sₜ, the full unmasked future poses ŝ_{t+1:t+K}, and the binary future-pose mask. In some embodiments, the controller 516 is also a fully-connected network, which observes the current state sₜ and the sampled latent zₜ to produce αₜ. In some embodiments, the prior module 510 can be as described below in conjunction with FIG. 6.

In some embodiments, the latent distribution can be modeled during training using a residual encoder zₜ˜N(μₜ^{p}+μₜ^{q},σₜ^{p}) with a linearly increasing KL-divergence coefficient. Then, during inference, the latent is sampled directly from the prior zₜ˜ N(μₜ^{p},σₜ^{p}). To train the motion tracking model 151, the model trainer 116 can optimize a proxy reconstruction loss via direct reinforcement learning optimization. The reward during training can be formulated as a full-body mimic and viewed through the lens of the goal-conditioned reinforcement learning framework. In some embodiments, the policy's action distribution is represented using a multi-dimensional Gaussian with a fixed diagonal covariance matrix σ^{π}=exp(−2.9), and the reward rₜ defined according to:

$${r}_{t} = r ( {\hat{q}}_{t} , {q}_{t} ) = {w}^{gt} {r}_{t}^{gt} + {w}^{g r} {r}_{t}^{g r} + {w}^{rh} {r}_{t}^{rh} + {w}^{jav} {r}_{t}^{jav} + {w}^{enrg} {r}_{t}^{enrg} , \qquad ( 2 )$$

where the individual components are defined as: global translation root-height reward rₜ^{rh}=e^{-c}^{^{rh}}∥\hat{p}ₜ^{root-hright}−pₜ^{root-height}∥, and joint angular velocity rₜjav=e^{-cjvv∥\hat{v}}^{ₜ}^{-v}^{ₜ}^{∥}. To mitigate jitter and promote more stable behaviors, an energy reduction reward rₜ^{eng}=−Σj|τⱼωⱼ|² is included, where τⱼ and ωⱼ correspond to the torque and angular velocity of joint j·w and c can be manually specified coefficients for combining the various reward terms. In some embodiments, at each step during training, a full-body motion tracker observes the current character state, consisting of the current 3D body pose and velocity, canonicalized to the character's local coordinate frame:

$${s}_{t} = ( {θ}_{t} ⊖ {θ}_{t}^{root} , {p}_{t} - {p}_{t}^{root} , {w}_{t} ⊖ {θ}_{t}^{root} ) , \qquad ( 3 )$$

where θdenotes the difference between two quaternions. The target poses are represented using, for example, K=10 future poses. Where each joint \hat{q}ₜ₊ₖ^{j} is canonicalized relative to the current pose

$${\hat{q}}^{j} = ( {\hat{θ}}^{j} ⊖ {θ}_{t}^{j} , {\hat{θ}}^{j} ⊖ {θ}_{t}^{root} , {\hat{p}}^{j} - {p}_{t}^{j} , {\hat{p}}^{j} - {p}_{t}^{root} ) . \qquad ( 4 )$$

In addition, a pose with missing information is referred to herein as \hat{q}^{sparse}. A pose with missing information may be a result of masking ground-truth motion capture data, or, for example, sparse input provided by an animator.

In order to support “any-joint any-time,” within the provided context length, at inference time, the motion tracking model 151 can be presented with any sparsity pattern, based on the requirements of an animator. To handle such scenarios, the motion tracking model 151 can be trained with various sparsity patterns, by randomly sampling joint masks and time gaps, sequences of frames in which all joints are masked out. This results in a mask ∈ [symbol] ^{K·(J·2)}, K future steps with/joints supporting both position and rotation constraints.

As described, in some embodiments, the model trainer 116 can also implement early termination, if the received character motion in the updated state 524 has deviated too much in position and/or orientation (or based on any other similarity metric) from the sampled motion 502 that is used as a reference, and adaptive state initialization, which complements early termination by prioritizing training on motions that are the most difficult to imitate. The goal of early termination is twofold: (1) dynamic motions tend to be harder track, and early termination ensures the training process focuses on the motions “near” to the target motion; and (2) as rewards are non-negative, ending the episode early serves as a strong reinforcement optimization signal for the agent to remain within the tracking boundaries. Specifically, in some embodiments, an episode can be terminated at any state, if any of the reward components rₜ^{gt},rₜ^{gr},rₜ^{rh},rₜ^{jav},rₜ^{enrg} drops below a given threshold. Experience has shown that a threshold of 0.2 works well. For the adaptive state initialization, in some embodiments each recorded motion can be partitioned into segments (e.g., 0.5 seconds long segments). During training, the initialization module 402 of the model trainer 116 can maintain a per-segment sampling rate proportional to the number of times the policy failed to track a frame belonging to that segment. The per-segment sampling rate can also be smoothed over time using standard discounted accumulation, where at each epoch e the sampling rate for segment i is updated according to:

$${w}_{e}^{i} = \frac{num {failures}^{i}}{total {frames}^{i}} + 0.7 \cdot {w}_{e - 1}^{i} . \qquad ( 5 )$$

When a new episode begins, the target motion, and initial time within that motion, can be sampled proportional to the weights of equation (5).

Once trained, during the inference stage, the prior module 510 and the controller 516 can then be used to produce full-body physically animated character motion based on sparse constraints from a user. More specifically, the user can provide the initial pose for the character 160 and a set of constraints (joint positions and rotations) for subsequent timesteps. For example, the user could draw a curve that a particular joint (e.g., a pelvis joint) should follow, or different curves for different joints (e.g., a head joint and hand joints). At each timestep, a latent zₜ is sampled from the prior distribution 512 zₜ˜N(μₜ^{p},σₜ^{p}), based on the current character state and the sparse future constraints. The current state, alongside the sampled latent, is then provided to the controller 516 that generates realistic full-body motions that adhere to the user specifications. More generally, the sparse motion constraints provided by the user can specify the positions and/or orientations of any number of joints of a character in any number of frames of an animation, including a fully-observed motion in which no masking is applied. That is, the controller 516 supports tracking any-joint-any-time, ranging from all joints in all frames and up to no joints visible at all.

FIG. 6 is a more detailed illustration of the prior module 510 of FIG. 5, according to various embodiments. As shown, the prior module 510 takes as input a current pose 620 and a number K of target future joint positions 602. A per-joint representation 604 of the target future joint positions 602 and a per-joint representation 622 of the current pose represent each pose by individual joints of the pose. A joint embedding JE^{j}, which is a positional-joint embedding, is appended to each future joint j constraint. For example, joint embedding 608 is appending to future joint constraint 606 to generate a combined representation 610. The prior module 510 encodes 609 the combined representations using an encoder (not shown), which is shared across all joint representations, to generate a position encoding 612, which is masked 614 on joints and time to generate a masked joint position encoding 616. The prior module 510 encodes 611 the per-joint representation 622 of the current full-body pose using a separate encoder (not shown). Capturing the time domain can be achieved by applying a standard positional encoding. The prior module 510 also appends, to the masked joint position encoding 616, a type embedding TE^{type} for each entry type 618. The prior module 510 then feeds the masked joint position encoding 616 with the appended type embeddings 618 to a transformer encoder 170, which outputs the prior distribution 512. The transformer encoder 170 learns to attend to the current pose and every future joint in every time frame up to K future time frames based on what is important.

More formally, in some embodiments, the input to the prior module 510 having a transformer architecture includes the current state sₜ, the K future poses [\hat{q}ₜ₊₁, . . . , \hat{q}_{t+K}], and a text encoding for the current motion textₜ. The inputs are pre-processed as follows. For future poses, each joint \hat{q}_{T}^{j}, in any future pose, is concatenated a joint embedding JE^{j}. An encoder, shared across all future joint constraints, encodes 609 the combined representation (ê_{τ}^{j}), followed by a positional encoding across the time domain (\tilde{e}ᵣ^{j}). Doing so results in a future-pose encoding tensor [\tilde{e}ₜ₊₁, . . . , \tilde{e}_{t+K}]∈ [symbol] ^{K·J·2×dim}, J joints, K future poses, and 2 possible constraint types (position, rotation). For a current pose, the pose qₜ is encoded 611 to eₜ, using an encoder that is different than the encoder used for the future joint constraints. The resulting representation (K+1, dim) is then fed into the transformer encoder 170, followed by two output heads, to produce the prior (μₜ^{p},σₜ^{p}) 512.

FIG. 7 is a more detailed illustration of the control application 146 of FIG. 1, according to various embodiments. As shown, the control application 146 includes the motion tracking model 152. In operation, the control application 146 receives sparse motion constraints 702. The sparse motion constraints 702 can specify the positions and/or orientations of any number of joints of a character in any number of frames of an animation, including a fully-observed motion in which no masking is applied. The sparse motion constraints 702 can be specified by a user in any technically feasible manner, such as via a graphical user interface (GUI), in some embodiments. The control application 146 inputs the sparse motion constraints 702 and a current state of the character into the motion tracking model 152 to generate an action 704. Then, the control application 146 controls a character within the environment 170 using the generated action. For example, in some embodiments, the control application 146 can transmit the action 704 to a controller of the character, such as a PD controller, that controls joints of the character to move within the environment 170 according to the action. The control application 146 receives an updated state 706 of the character from the environment 107, which can be used along with the sparse motion constraints 702 to generate further actions for controlling the character.

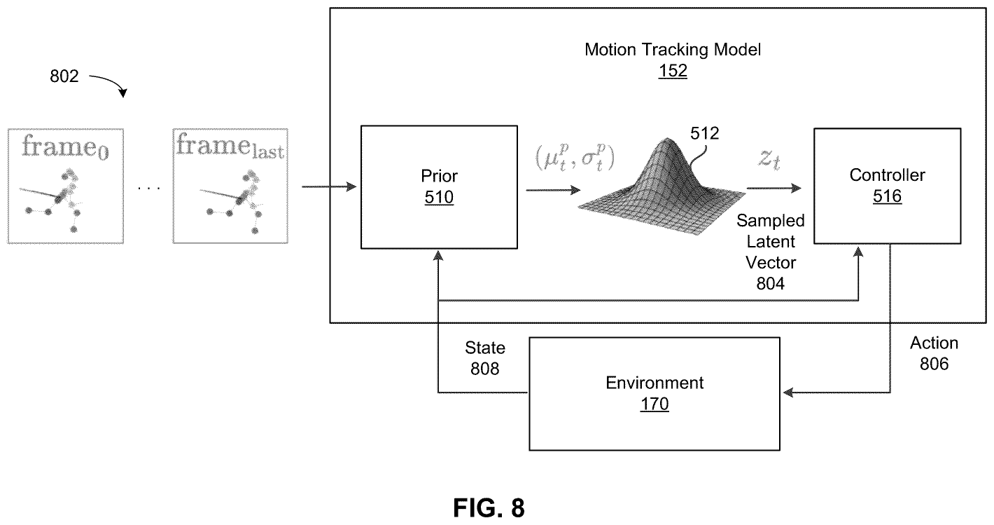

FIG. 8 is a more detailed illustration of how the motion tracking model 152 of FIG. 7 is used to control a character, according to various embodiments. As shown, given sparse motion constraints 802 (which can be similar to the sparse motion constraints 702, described above in conjunction with FIG. 7) as input, the control application 146 uses the prior module 510 generate the prior distribution 512 based on the sparse motion constraints and a current state of a character, and the control application 146 then samples the prior distribution 512 to obtain a latent vector 804. Then, the control application 146 inputs the sampled latent vector 804 and a current state 808 of the character into the controller 516, which outputs an action 806. The control application 146 controls a character within the environment 170 using the action 806. As described, in some embodiments, the control application 146 can transmit the action 806 to a controller of the character, such as a PD controller, that controls joints of the character to move within the environment 170 according to the action. Thereafter, the control application 146 receives an updated state of the character from the environment 107, and the foregoing process can be repeated to generate another action for controlling the character at a subsequent time step, and so forth. It should be noted that the motion tracking model 152 does not include the encoder 508 of the motion tracking model 151, because the encoder 508 can be discarded after training of the motion tracking model 151.

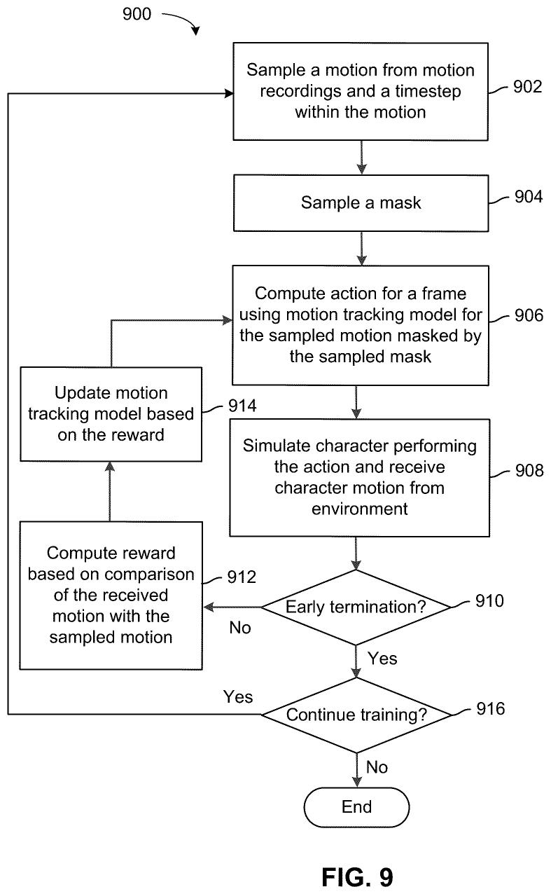

FIG. 9 sets forth a flow diagram of method steps for training a motion tracking model, according to various embodiments. Although the method steps are described in conjunction with FIGS. 1-8, persons skilled in the art will understand that any system configured to perform the method steps, in any order, falls within the scope of the present invention.

As shown, a method 900 begins at step 902, where the model trainer 116 samples a motion from the motion recordings 154 and a timestep within the motion. In some embodiments, the sampling can prioritize training on most difficult to imitate motions using a per-segment motion sampling rate that is proportional to the number of times the motion tracking model 151 failed to track a frame belonging to that segment, relative to the total number of frames spent within that segment and smoothed over time using standard discounted accumulation, as described above in conjunction with FIG. 5.

At step 904, the model trainer 116 samples a mask for the sampled motion. In some embodiments, the mask can mask out randomly selected joints from randomly selected frames of the sampled motion, which can include no masking if no joints or frames are randomly selected.

At step 906, the model trainer 116 computes an action for a frame using the motion tracking model 151 for the sampled motion masked by the sampled mask. In some embodiments, the prior module 510 of the model trainer 116 generates the latent distribution 512 given the sparse motion constraints and a current state of a character as inputs, and the model trainer 116 samples the latent distribution 512 to obtain a latent vector. Then, the model trainer 116 inputs the latent vector and the current state of the character into the controller 516, which outputs the action.

At step 908, the model trainer 116 simulates the character performing the action and receives a character motion from the environment 170. In some embodiments, the model trainer 116 transmits the action computed at step 906 to a controller of the character, such as a PD controller, that controls joints of the character to move within the environment 170 according to the action.

At step 910, the model trainer 116 determines whether to terminate training using the sampled motion and the sampled mask early. In some embodiments, the model trainer 116 determines to terminate early if the received character motion has deviated too much in position and/or orientation from the sampled motion that is used as a reference, as described above in conjunction with FIG. 5. More generally, in some embodiments, the model trainer 116 can determine to terminate early based on a failure that is defined as a mismatch in any technically feasible similarity metric

If the model trainer 116 determines not to terminate early, then at step 912, the model trainer 116 computes a reward based on a comparison of the received motion with the sampled motion. In some embodiments, the reward can include (1) a term that rewards lesser distances between received positions of joints and positions of the joints in the sampled motion, (2) a term that rewards lesser angles between received rotations of joints and rotations of joints in the sampled motion, (3) a term that rewards lesser differences between a received height of a root joint and a height of the root joint in the sampled motion, (4) a term that rewards lesser differences between received velocities of the joints and velocities of the joints in the sampled motion, and (5) a term that penalizes energy consumption in the received motion. In some embodiments, the reward of equation (2) can be used. More generally, in some embodiments, the reward can be any metric of comparison between the generated motion and the received motion that is used as a target kinematic motion.

At step 914, the model trainer 116 updates parameters of the motion tracking model 151 based on the reward computed at step 912. In some embodiments, the model trainer 116 can update the parameters of the encoder 508, the prior module 510, and the controller 516 in the motion tracking model 151 using the reward and a backpropagation technique. In some embodiments, a PPO technique can be employed. The method 900 then returns to step 906, where the model trainer 116 computes an action for another frame using the motion tracking model 151 for the sampled motion masked by the sampled mask.

On the other hand, if the model trainer 116 determines to terminate early at step 910, then at step 916, the model trainer 116 determines whether to continue training. For example, training can terminate after a specific number of training iterations or if the reward does not improve over a number of training iterations. If the model trainer 116 determines to continue training, then the method 900 returns to step 902, where the model trainer 116 samples another motion from the motion recordings 154 and a timestep within the motion. On the other hand, if the model trainer 116 determines to stop training, then the method 900 ends.

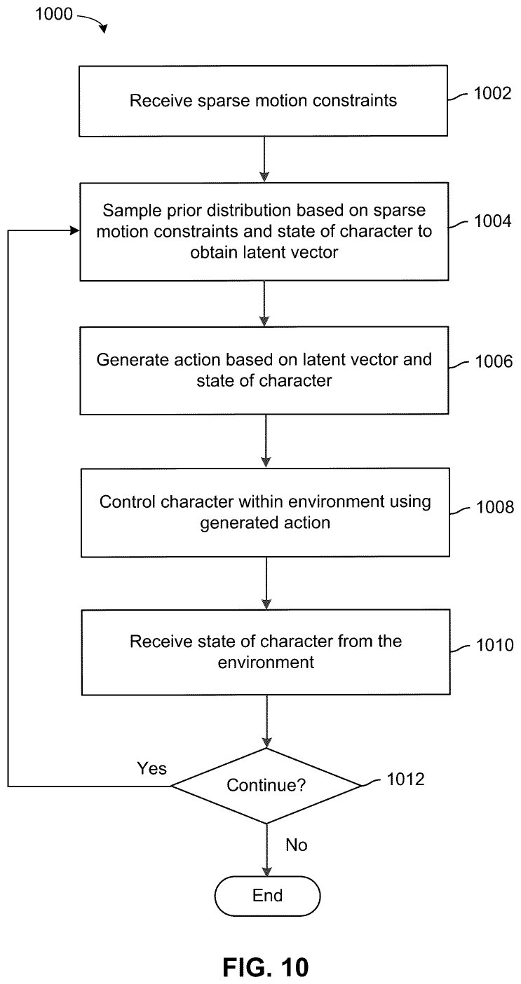

FIG. 10 is a flow diagram of method steps for generating an animation of a character given sparse motion constraints, according to various embodiments. Although the method steps are described in conjunction with FIGS. 1-8, persons skilled in the art will understand that any system configured to perform the method steps, in any order, falls within the scope of the present invention.

As shown, a method 1000 begins at step 1002, where the control application 146 receives sparse motion constraints. The sparse motion constraints can be specified by a user in any technically feasible manner, such as via a GUI. The sparse motion constraints can include positions and/or orientations of any number of joints of character in any number of frames of an animation, including a fully-observed motion in which no masking is applied, thereby supporting tracking any-joint-any-time, ranging from all joints in all frames and up to no joints visible at all.

At step 1004, the control application 146 samples the prior distribution 512 based on the sparse motion constraints and a state of a character to obtain a latent vector. In some embodiments, the control application 146 inputs the sparse motion constraints and the state of the character into the prior module 510, which generates the prior distribution 512, and the control application 146 then samples the prior distribution 512 to obtain the latent vector.

At step 1006, the control application 146 generates an action based on the latent vector and the state of the character. In some embodiments, the control application 146 inputs the latent vector and a current state of the character into the controller 516, which outputs the action.

At step 1008, the control application 146 controls the character within the environment 170 using the generated action. In some embodiments, the control application 146 transmits the action to a controller of the character, such as a PD controller, that controls joints of the character to move within the environment 170 according to the action.

At step 1010, the control application 146 receives a state of the character from the environment 107. The state can include updated joint positions of the character after performing the action.

At step 1012, if the control application 146 determines to continue controlling the character, then the method 1000 returns to step 1004, where the control application 146 again samples the prior distribution 512 based on the sparse motion constraints received at step 1002 and the state of character received at step 1010 to obtain another latent vector.

In sum, techniques are disclosed for animating characters using sparse motion constraints. In some embodiments, the sparse motion constraints can specify the positions and/or orientations of any number of joints of a character in any number of frames of an animation. Given the sparse motion constraints, a control application samples a prior latent distribution generated via a trained motion tracking model given the sparse motion constraints and a current state of a character to obtain a sampled latent vector. The character can be a virtual character in a computer-based environment or a physical robot in a real-world environment, and the current state of the character can be received from the computer-based environment or sensed using sensors in the real-world environment. The control application inputs the sampled latent vector and the current state of the character into a controller of the motion tracking model to generate an action. Thereafter, the control application can control the character within the computer-based environment or the real-world environment using the action. Control of the character can result in an updated state of the character, and the foregoing process can be repeated to generate another action for controlling the character using the updated state of the character, the sparse motion constraints, and the motion tracking model.

A model trainer trains the motion tracking model, which can be a variational autoencoder (VAE) in some embodiments. In some embodiments, the model trainer first samples a motion and a timestep within the motion from a set of motion recordings. The model trainer then samples a mask that is used to mask out random joints and/or frames from the sampled motion. The model trainer computes an action for each frame using the motion tracking model, the masked motion, and a current state of the character. The model trainer simulates the character performing the action within the environment and receives a motion of the character from the environment. Then, the model trainer computes a reward based on a comparison of the received motion with the sampled motion, and the model trainer updates parameters of the motion tracking model based on the reward.

At least one technical advantage of the disclosed techniques relative to the prior art is that, with the disclosed techniques, a physical or virtual character can be animated by specifying the positions and orientations of a subset of the joints, rather than all of the joints, of a character in any number of frames of an animation. In addition, the disclosed techniques can generate animations that are more physically realistic relative to what can be achieved by animations generated using kinematic models that do not consider the forces that cause the joints of a character to move. These technical advantages represent one or more technological improvements over prior art approaches.

1. In some embodiments, a computer-implemented method for animating characters comprises receiving a first state of a character and one or more constraints on one or more motions associated with a subset of joints belonging to the character, generating, via a trained machine learning model and based on the first state and the one or more constraints, a first action for the character to perform, and causing the character to perform the first action within a computer-based or physical environment.

2. The computer-implemented method of clause 1, wherein generating the first action comprises sampling a prior distribution based on the first state and the one or more constraints to generate a latent vector, and processing the latent vector and the first state using a controller included in the trained machine learning model to generate the first action.

3. The computer-implemented method of clauses 1 or 2, further comprising processing the first state and the one or more constraints using a transformer encoder to generate the prior distribution.

4. The computer-implemented method of any of clauses 1-3, further comprising training a first machine learning model to generate the trained machine learning model, wherein the first machine learning model comprises an encoder.

5. The computer-implemented method of any of clauses 1-4, wherein the trained machine learning model comprises at least one of a trained variational autoencoder (VAE) or a trained generative model.

6. The computer-implemented method of any of clauses 1-5, further comprising generating, via the trained machine learning model and based on the one or more constraints and a second state of the character subsequent to performing the first action, a second action for the character to perform, and causing the character to perform the second action within the computer-based or physical environment.

7. The computer-implemented method of any of clauses 1-6, further comprising training a first machine learning model to produce the trained machine learning model by sampling a first motion from a set of motion recordings and a timestep within the first motion to generate a sampled motion, removing at least one joint or at least one frame within the sampled motion to generate a masked motion, generating, via the first machine learning model and based on a second state of the character and the masked motion, a second action for the character to perform, causing the character to perform the second action within the computer-based environment to reach a third state of the character, and updating one or more parameters of the first machine model based on a comparison between the third state and a fourth state of the character included in the sampled motion.

8. The computer-implemented method of any of clauses 1-7, further comprising training a first machine learning model to produce the trained machine learning model based on a reward that is a metric of comparison between motions generated by the first machine learning model and motions sampled from a set of motion recordings.

9. The computer-implemented method of any of clauses 1-8, wherein a controller that controls one or more joints of the character causes the character to move according to the first action.

10. The computer-implemented method of any of clauses 1-9, wherein the character comprises either a virtual character or a physical robot.

11. In some embodiments, one or more non-transitory computer-readable media store instructions that, when executed by at least one processor, cause the at least one processor to perform the steps of receiving a first state of a character and one or more constraints on one or more motions associated with a subset of joints belonging to the character, generating, via a trained machine learning model and based on the first state and the one or more constraints, a first action for the character to perform, and causing the character to perform the first action within a computer-based or physical environment.

12. The one or more non-transitory computer-readable media of clause 11, wherein generating the first action comprises sampling a prior distribution based on the first state and the one or more constraints to generate a latent vector, and processing the latent vector and the first state using a controller included in the trained machine learning model to generate the first action.

13. The one or more non-transitory computer-readable media of clauses 11 or 12, wherein the instructions, when executed by the at least one processor, further cause the at least one processor to perform the step of processing the first state and the one or more constraints using a transformer encoder to generate the prior distribution.

14. The one or more non-transitory computer-readable media of any of clauses 11-13, wherein the instructions, when executed by the at least one processor, further cause the at least one processor to perform the step of training a first machine learning model to generate the trained machine learning model, wherein the first machine learning model comprises an encoder.

15. The one or more non-transitory computer-readable media of any of clauses 11-14, wherein the instructions, when executed by the at least one processor, further cause the at least one processor to perform the step of training a first machine learning model to produce the trained machine learning model by sampling a first motion from a set of motion recordings and a timestep within the first motion to generate a sampled motion, removing at least one joint or at least one frame within the sampled motion to generate a masked motion, generating, via the first machine learning model and based on a second state of the character and the masked motion, a second action for the character to perform, causing the character to perform the second action within the computer-based environment to reach a third state of the character, and updating one or more parameters of the first machine model based on a comparison between the third state and a fourth state of the character included in the sampled motion.

16. The one or more non-transitory computer-readable media of any of clauses 11-15, wherein the instructions, when executed by the at least one processor, further cause the at least one processor to perform the step of terminating training of the first machine learning model using the sampled motion based on a similarity between the third state and the fourth state being less than a predefined threshold.

17. The one or more non-transitory computer-readable media of any of clauses 11-16, wherein the instructions, when executed by the at least one processor, further cause the at least one processor to perform the step of training a first machine learning model to produce the trained machine learning model based on a reward that is a metric of comparison between motions generated by the first machine learning model and motions sampled from a set of motion recordings.

18. The one or more non-transitory computer-readable media of any of clauses 11-17, wherein a controller that controls one or more joints of the character causes the character to move according to the first action.

19. The one or more non-transitory computer-readable media of any of clauses 11-18, wherein the environment is at least one of a simulation environment, an extended reality (XR) environment, a game environment, or a physical environment.

20. In some embodiments, a system comprises one or more memories storing instructions, and one or more processors that are coupled to the one or more memories and, when executing the instructions, are configured to receive a first state of a character and one or more constraints on one or more motions associated with a subset of joints belonging to the character, generate, via a trained machine learning model and based on the first state and the one or more constraints, a first action for the character to perform, and cause the character to perform the first action within a computer-based or physical environment.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for animating characters, the method comprising:
receiving a first state of a character and one or more constraints on one or more motions associated with a subset of joints belonging to the character;
generating, via a trained machine learning model and based on the first state and the one or more constraints, a first action for the character to perform; and
causing the character to perform the first action within a computer-based or physical environment.

2. The computer-implemented method of claim 1, wherein generating the first action comprises:
sampling a prior distribution based on the first state and the one or more constraints to generate a latent vector; and
processing the latent vector and the first state using a controller included in the trained machine learning model to generate the first action.

3. The computer-implemented method of claim 2, further comprising processing the first state and the one or more constraints using a transformer encoder to generate the prior distribution.

4. The computer-implemented method of claim 2, further comprising training a first machine learning model to generate the trained machine learning model, wherein the first machine learning model comprises an encoder.

5. The computer-implemented method of claim 1, wherein the trained machine learning model comprises at least one of a trained variational autoencoder (VAE) or a trained generative model.

6. The computer-implemented method of claim 1, further comprising:
generating, via the trained machine learning model and based on the one or more constraints and a second state of the character subsequent to performing the first action, a second action for the character to perform; and
causing the character to perform the second action within the computer-based or physical environment.

7. The computer-implemented method of claim 1, further comprising training a first machine learning model to produce the trained machine learning model by:
sampling a first motion from a set of motion recordings and a timestep within the first motion to generate a sampled motion;
removing at least one joint or at least one frame within the sampled motion to generate a masked motion;
generating, via the first machine learning model and based on a second state of the character and the masked motion, a second action for the character to perform;
causing the character to perform the second action within the computer-based environment to reach a third state of the character; and
updating one or more parameters of the first machine model based on a comparison between the third state and a fourth state of the character included in the sampled motion.

8. The computer-implemented method of claim 1, further comprising training a first machine learning model to produce the trained machine learning model based on a reward that is a metric of comparison between motions generated by the first machine learning model and motions sampled from a set of motion recordings.

9. The computer-implemented method of claim 1, wherein a controller that controls one or more joints of the character causes the character to move according to the first action.

10. The computer-implemented method of claim 1, wherein the character comprises either a virtual character or a physical robot.

11. One or more non-transitory computer-readable media storing instructions that, when executed by at least one processor, cause the at least one processor to perform the steps of:
receiving a first state of a character and one or more constraints on one or more motions associated with a subset of joints belonging to the character;
generating, via a trained machine learning model and based on the first state and the one or more constraints, a first action for the character to perform; and
causing the character to perform the first action within a computer-based or physical environment.

12. The one or more non-transitory computer-readable media of claim 11, wherein generating the first action comprises:
sampling a prior distribution based on the first state and the one or more constraints to generate a latent vector; and
processing the latent vector and the first state using a controller included in the trained machine learning model to generate the first action.

13. The one or more non-transitory computer-readable media of claim 12, wherein the instructions, when executed by the at least one processor, further cause the at least one processor to perform the step of processing the first state and the one or more constraints using a transformer encoder to generate the prior distribution.

14. The one or more non-transitory computer-readable media of claim 13, wherein the instructions, when executed by the at least one processor, further cause the at least one processor to perform the step of training a first machine learning model to generate the trained machine learning model, wherein the first machine learning model comprises an encoder.

15. The one or more non-transitory computer-readable media of claim 11, wherein the instructions, when executed by the at least one processor, further cause the at least one processor to perform the step of training a first machine learning model to produce the trained machine learning model by:
sampling a first motion from a set of motion recordings and a timestep within the first motion to generate a sampled motion;
removing at least one joint or at least one frame within the sampled motion to generate a masked motion;
generating, via the first machine learning model and based on a second state of the character and the masked motion, a second action for the character to perform;
causing the character to perform the second action within the computer-based environment to reach a third state of the character; and
updating one or more parameters of the first machine model based on a comparison between the third state and a fourth state of the character included in the sampled motion.

16. The one or more non-transitory computer-readable media of claim 15, wherein the instructions, when executed by the at least one processor, further cause the at least one processor to perform the step of terminating training of the first machine learning model using the sampled motion based on a similarity between the third state and the fourth state being less than a predefined threshold.

17. The one or more non-transitory computer-readable media of claim 11, wherein the instructions, when executed by the at least one processor, further cause the at least one processor to perform the step of training a first machine learning model to produce the trained machine learning model based on a reward that is a metric of comparison between motions generated by the first machine learning model and motions sampled from a set of motion recordings.

18. The one or more non-transitory computer-readable media of claim 11, wherein a controller that controls one or more joints of the character causes the character to move according to the first action.

19. The one or more non-transitory computer-readable media of claim 11, wherein the environment is at least one of a simulation environment, an extended reality (XR) environment, a game environment, or a physical environment.

20. A system, comprising:
one or more memories storing instructions; and
one or more processors that are coupled to the one or more memories and, when executing the instructions, are configured to:
receive a first state of a character and one or more constraints on one or more motions associated with a subset of joints belonging to the character,
generate, via a trained machine learning model and based on the first state and the one or more constraints, a first action for the character to perform, and
cause the character to perform the first action within a computer-based or physical environment.
